(19) United States
(12) Patent Application Publication
(10) Pub. No.: US 2022/0097788 A1
(43) Pub. Date: Mar. 31, 2022

(54) VARIABLE-FORM CUSHION STRUCTURE OF ELECTRIC VEHICLE

(71) Applicants: Yu Wen, Chongqing (CN); Jing Wen, Chongqing (CN)

(72) Inventors: Yu Wen, Chongqing (CN); Jing Wen, Chongqing (CN)

(21) Appl. No.: 17/421,018

(22) PCT Filed: Jan. 9, 2020
(86) PCT No.: PCT/CN2020/071125

§ 371 Date: Jul. 7, 2021

(30) Foreign Application Priority Data
Jan. 10, 2019 (CN) 201920043422.5

(51) Int. Cl. B62J 1/08; B62D 51/02

(52) U.S. Cl. CPC B62J 1/08; B62D 51/02

(57) ABSTRACT

The utility model relates to the technical field of a cushion structure of an electric vehicle, and discloses a variable-form cushion structure of electric vehicle. The variable-form cushion structure specifically comprises a chassis with sliding rails, and a cushion unit, wherein, the chassis is arranged longitudinally, and the sliding rails extend longitudinally; the cushion unit comprises a support plate and a seat plate, and the lower end of the seat, plate is hinged to the upper end of the support plate; the lower end of the support plate is fixedly arranged, and the upper end of the seat plate is connected in a movable way with the sliding rails; when the upper end of the seat plate is located at the upper parts of the sliding rails, the seat plate is obliquely arranged relatively to the ground; and when the upper end of the seat plate moves to the lower parts of the sliding rails, the seat, plate is arranged, horizontally. The cushion structure of the electric vehicle can be switched among different modes according to the driver's requirements, so as to meet different requirements and improve the driver's driving experience and safety.

### TECHNICAL FIELD

The utility model relates to the technical field of cushion structures of electric vehicles, in particular to a variable-form cushion structure of electric vehicle.

### BACKGROUND ART

The electric vehicle, namely power-driven vehicle, is also called electric drive vehicle; the electric vehicles include AC electric vehicles and DC electric vehicles; the electric vehicles commonly referred to are the vehicles using batteries as an energy source, which can move through mechanical energy converted from electric energy via a controller, a motor and other components, with the speed changed by control over the magnitude of current.

At present, with technological development, people often use the electric vehicles for daily travel, and the electric vehicles are diversified in forms and sizes; and when using the electric vehicle, a driver can stand, sit, lie, etc., so that different driving requirements are met.

In the prior art, a seat cushion of an electric vehicle is fixed in form, and cannot be changed in multiple forms; and for switching among multiple positions, including standing, sitting, lying and the like, of the driver, the seat cushion cannot be changed to the corresponding form, and consequently the driving experience and safety of the driver are affected.

### Content of Utility Model

The utility model aims to provide a variable-form cushion structure of electric vehicle, with the purpose of solving the problem of a single form of the seat cushion of the electric vehicle in the prior art.

The utility model is achieved in this way that a variable-form cushion structure of electric vehicle is characterized by comprising a chassis with sliding rails, and a cushion unit, wherein, the chassis is arranged longitudinally, and the sliding rails extend longitudinally; the cushion unit comprises a support plate and a seat plate, and the lower end of the seat plate is hinged to the upper end of the support plate; the lower end of the support plate is fixedly arranged, and the upper end of the seat plate is connected in a movable way with the sliding rails; when the upper end of the seat plate is located at the upper parts of the sliding rails, the seat plate is obliquely arranged relatively to the ground; and when the upper end of the seat plate moves to the lower parts of the sliding rails, the seat plate is arranged horizontally.

Preferably, a first rotating shaft is arranged at the upper end of the seat plate; the first rotating shaft is arranged transversely, and attached to the chassis; and the sliding rails run through the first rotating shaft, and in the longitudinal direction, the first rotating shaft can move relative to the sliding rails, so as to achieve the switching between horizontal arrangement and oblique arrangement of the seat plate.

Preferably, the first rotating shaft is arranged at the upper end of the seat plate; the first rotating shaft is arranged transversely, and connected in a movable or slidable way with the chassis; and in the longitudinal direction, the first rotating shaft can move relative to the sliding rails, so as to achieve the switching between horizontal arrangement and oblique arrangement of the seat plate.

Wherein, locking structures used for relatively fixing the upper part of the seat plate to the chassis are arranged between the seat plate and the chassis.

Preferably, a second rotating shaft is arranged at the upper end of the support plate, and the lower end of the seat plate is connected in a movable way with the second rotating shaft; and the second rotating shaft as well as the first rotating shaft is arranged in parallel.

Preferably, an inner space is formed between the cushion unit and the chassis, and a control element and/or a power supply is arranged in the inner space.

Preferably, the chassis comprises a foot pad; a third rotating shaft is arranged at the lower end of the support plate; the third rotating shaft is arranged transversely, and attached to the chassis; and the foot pad is connected, in a movable way with the third rotating shaft.

Preferably, the chassis comprises the foot pad; the third rotating shaft is arranged at the lower end of the support plate; the third rotating shaft is arranged transversely and connected with the chassis; and the foot pad is installed on the chassis or at the lower end of the support plate.

Preferably, the chassis comprises a base, and the sliding rails are arranged on the base; the lower end of the support plate is attached to the base, and from the lower end of the support plate to the upper end of the support plate, the support plate is gradually away from the base.

Preferably, the support plate is connected with the set position of the lower end of the base through the third rotating shaft, and the third rotating shaft is installed on the base; the support plate is assembled on the third rotating shaft, and it can rotate around the third rotating shaft; or the third rotating shaft is installed on the support plate, and driven by the support plate to rotate around the chassis.

Compared with the prior art, the variable-form cushion structure of electric vehicle, provided by the utility model, has the effects that when the electric vehicle is in a standing mode, the driver stands on the chassis arranged longitudinally, and the upper end of the seat plate is located at the upper parts of the sliding rails; the seat plate is obliquely arranged relative to the ground, and the chassis and the seat plate play a role in supporting the driver, so that the standing mode of the electric vehicle is achieved; when the electric vehicle needs to be switched to the sitting mode, the upper end of the seat plate can move to the lower parts of the sliding rails, so that the seat plate is arranged, horizontally; the driver sits on the seat plate, and the sitting mode is achieved; the form of the cushion structure of the electric vehicle can be switched among different modes according to the requirements of the driver, and different requirements are met; and the driving experience and safety of the driver are improved.

### BRIEF DESCRIPTION OF THE DRAWINGS

FIG. 1 is a stereoscopic view of a transformable electric vehicle provided by the embodiment of the utility model;

FIG. 2 is a stereoscopic diagram of the transformable electric vehicle provided by the embodiment of the utility model;

FIG. 3 is a main view of guide rails of the transformable electric vehicle provided by the embodiment of the utility model;

FIG. 4 is a stereoscopic view of the transformable electric vehicle provided by the embodiment of the utility model in the standing mode;

FIG. 5 is a stereoscopic view of the transformable electric vehicle provided by the embodiment of the utility model in the sitting mode;

FIG. 6 is a stereoscopic view of the transformable electric vehicle provided by the embodiment of the utility model in the driving mode;

FIG. 7 is a stereoscopic view of the transformable electric vehicle provided by the embodiment of the utility model in the lying mode.

### DETAILED DESCRIPTION OF THE PREFERRED EMBODIMENTS

In order to make the purpose, technical scheme and advantages of the utility model clearer, a detailed description of the utility model is given below in combination with the drawings and embodiments. It should be noted that the embodiments described here are only used to explain the utility model, but not limited to the utility model.

The same or similar labels in the figures of the embodiments correspond to the same or similar components; in the description of the utility model, it should be noted that the direction or position relationship indicated by the terms “upper”, “lower”, “left”, “right” and the like are based on the direction or position relationship shown in the figures, only for facilitating description of the utility model and simplification of the description, other than indicating or implying that the indicated devices or elements must have the specified direction, are structured and operated in the specified direction; and thus, the terms for describing the position relationship in the figures are only used for exemplary description, but cannot be understood as limitation to the patent, and those skilled in the art can understand the specific meaning of the above terms according to the specific conditions.

The followings are the detailed description on the implementation of the utility model in combination with the embodiments.

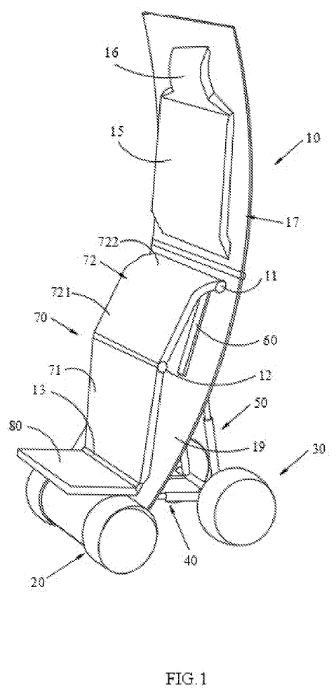

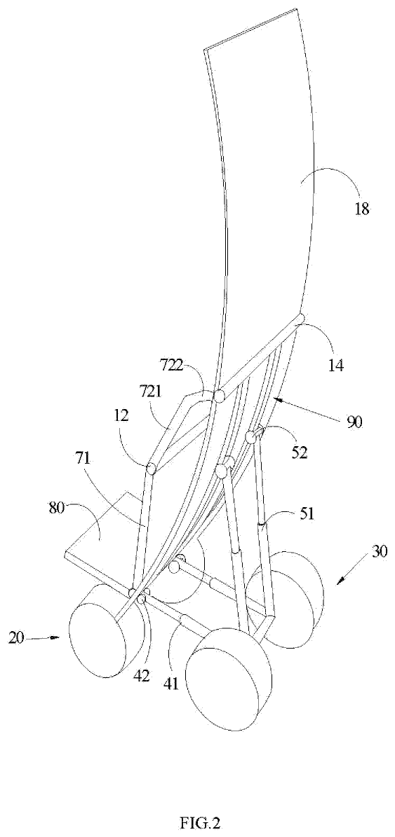

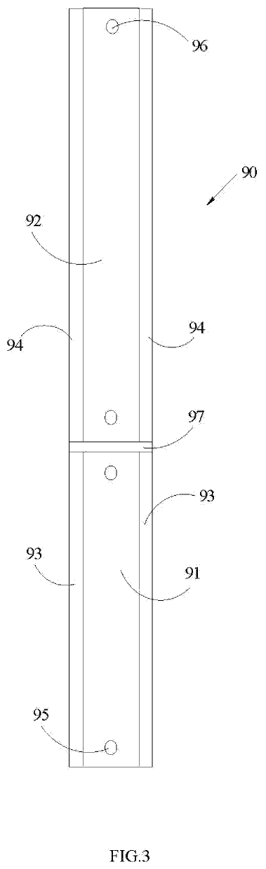

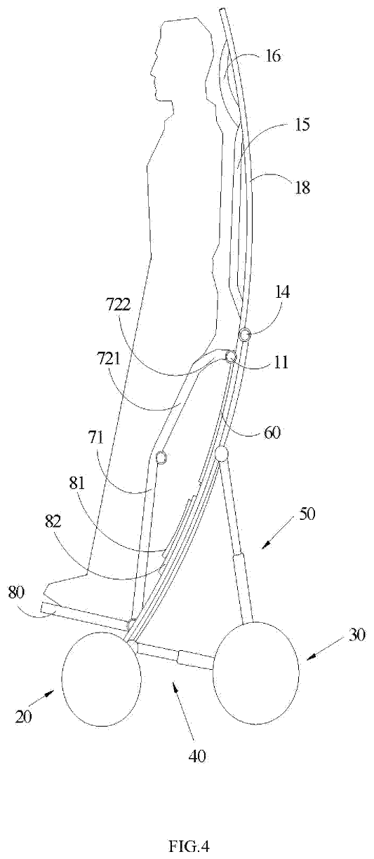

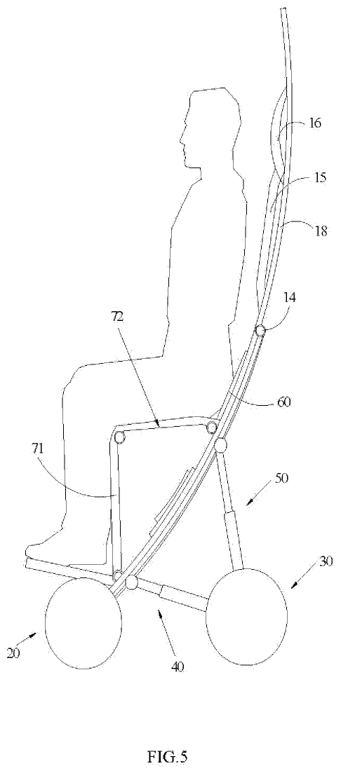

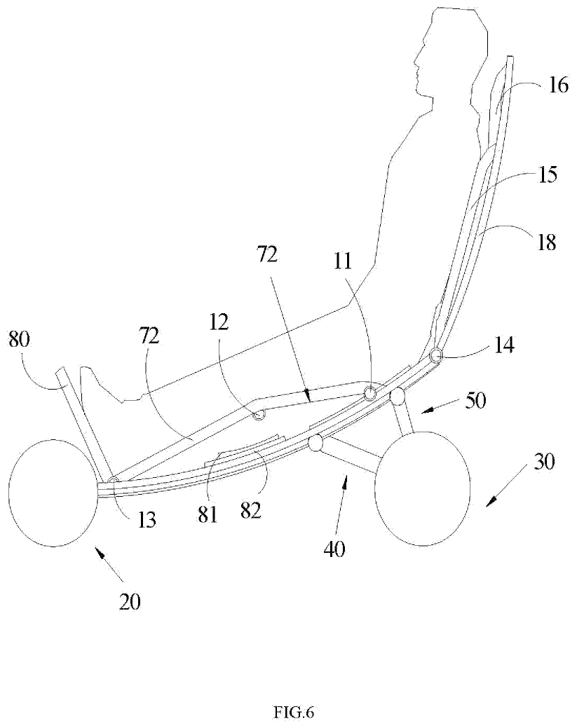

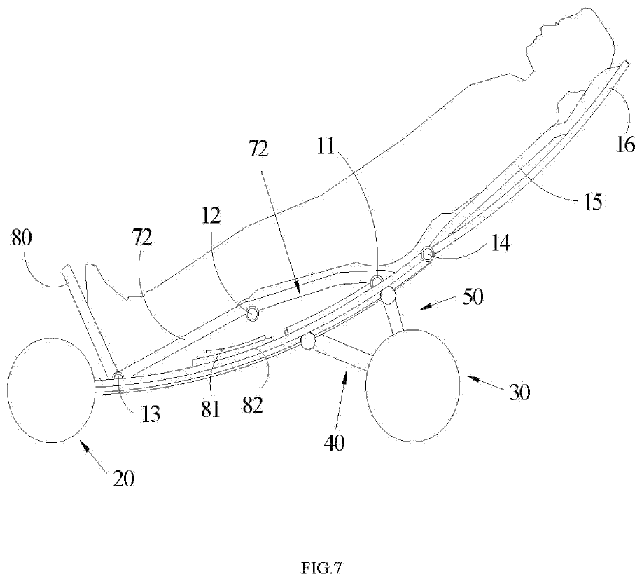

As shown in FIGS. 1-7, the optimal embodiments are provided for the utility model.

According to the variable-form cushion structure of electric vehicle, provided by the utility model, the problem of a single form of the seat cushion of the electric vehicle is solved.

The variable-form cushion structure of electric vehicle comprises a chassis 10 and a cushion unit 70; sliding rails 60 are arranged on the chassis 10; the chassis 10 is arranged longitudinally; the sliding rails 60 extend longitudinally; the cushion unit 70 comprises a support plate 71 and a seat plate 72, and the lower end of the seat plate 72 is hinged to the upper end of the support plate 71; the lower end of the support plate 71 is fixedly arranged; specifically, the support plate 71 is used in connection with other components, and is of a non-suspended structure; the upper end of the seat plate 72 is connected in a movable way with the sliding rails 60; when the upper end of the seat plate 72 is located at the upper parts of the sliding rails 60, the seat plate 72 is obliquely arranged, relatively to the ground; and when the upper end of the seat plate 72 moves to the lower parts of the sliding rails 60, the seat plate 72 is arranged horizontally.

According to the variable-form cushion, structure of electric vehicle, when the electric vehicle is in a standing mode, a driver stands on the chassis 10 arranged longitudinally, and the upper end of the seat plate 72 is located at the upper parts of the sliding rails; the seat plate 72 is obliquely arranged relative to the ground, and the chassis 10 and the seat plate 72 play a role in supporting the driver separately, so that the standing mode of the electric vehicle is achieved; when the electric vehicle needs to be switched to the sitting mode, the upper end of the seat, plate 72 can move to the lower parts of the sliding rails 60, so that the seat plate 72 is arranged horizontally; the driver sits on the seat plate, and the sitting mode is achieved; similarly, the seat plate 72 is controlled to slide to the corresponding position during deformation of the vehicle; in this way, the form of the cushion structure of the electric vehicle can be switched among different modes according to the requirements of the driver, and different requirements are met; and the driving experience and safety of the driver are improved.

A transformable, electric vehicle comprises a chassis 10, a front wheel group 20, a rear wheel group 30, transverse shrinkage rods 40 and longitudinal shrinkage rods 50, and an upper end face and a lower end face are arranged on the chassis 10; the front wheel group 20 is located in front of the rear wheel group 30, and the transverse shrinkage rods 40 can be contracted or stretched, and are arranged transversely; and the longitudinal shrinkage rods 50 can be retracted or stretched, and are arranged longitudinally.

Guide rails 90 are arranged on the lower end face of the chassis 10, and extend in the length direction of the chassis 10; one ends of the transverse shrinkage rods 40 are connected in a movable way with the guide rails 90, and the other ends of the transverse shrinkage rods 40 and the rear wheel group 30 are fixedly arranged; specifically, the other ends of the transverse shrinkage rods 40 and the rear wheel group 30 are of a connecting structure assembled together, and can be connected in a movable or fixed way; the lower ends of the longitudinal shrinkage rods 50 are attached to the rear wheel group 30, and the upper ends of the longitudinal shrinkage rods 50 are connected in a movable way with the guide rails 90; a cushion unit 70 and sliding rails 60 are arranged on the upper end face of the chassis 10, and the cushion unit 70 comprises a seat plate 72 for the driver to sit. The lower end of the cushion unit 70 is arranged fixedly, and specifically the lower end of the support plate 71 is used in connection with other components, and is of a non-suspended structure; the upper end of the cushion unit 70 is connected in a movable way with the sliding rails 60, and comprises the seat plate 72 for the driver to sit; and when the upper end of the cushion unit 70 is located at the lower parts of the sliding rails 60, the seat plate 72 is arranged horizontally.

According to the transformable electric vehicle provided by the utility model, through speed difference between front and rear wheels, the rear wheel group, the transverse shrinkage rods and the longitudinal shrinkage rods can be slide on the guide rails to change the wheel base; meanwhile, an included angle between the vehicle chassis and the ground is regulated, and additionally the rear wheel position further needs to be locked through locking devices located in rollers 42 so that the stable deformation is achieved.

When the electric vehicle is in the standing mode, the driver stands on the chassis 10 arranged longitudinally, and the transverse shrinkage rods 40 extend properly, so that the distance between the front wheel group 20 and the rear wheel group 30 is increased to ensure that the gravity center of the complete vehicle is located between the front and rear wheels, and the standing mode of the electric vehicle is achieved; when the electric vehicle needs to be switched to the sitting mode, the transverse shrinkage rods 40 and the longitudinal shrinkage rods 50 extend properly and separately, and the upper end of the cushion unit 70 can move to the lower parts of the sliding rails 60, so that the seat plate 72 is arranged horizontally to adapt to the sitting position of the driver; when the electric vehicle needs to be switched to the driving mode, one ends of the transverse shrinkage rods 40 can move on the guide rails 90 away from the front wheel group 20, and, move to the farthest position, and meanwhile the transverse shrinkage rods 40 are contracted to the shortest distance; the upper ends of the longitudinal shrinkage rods 50 can move to the farthest position away from the front wheel group 20, and the longitudinal shrinkage rods 50 are contracted to the shortest distance; the upper end of the cushion unit 70 can move to the upper parts of the sliding rails 60, so that the angle of the chassis 10 is changed to adapt to the running of the vehicle and the driving state of the driver; in this way, the form of the electric vehicle can be switched among different modes according to the requirements of the driver, and different requirements are met; and the driving experience and safety of the driver are improved.

In order to ensure the safety of the driver, the wheel base and speed at other positions in non-driving modes can be further limited through software in the electric vehicle, so that the optimal wheel base and speed of the electric vehicle can be obtained in different states only. For example:

When the electric vehicle is in the standing mode, the transverse shrinkage rods 40 extend properly, so that the distance between the front and rear wheels is increased to ensure that the gravity center of the complete vehicle is located between the front and rear wheels, and the stability of the vehicle is ensured. The wheel base adapts to the distribution of the gravity center of the complete vehicle through length regulation of the transverse shrinkage rods 40; in the standing state, the electric vehicle is limited to the lower speed, so that the driving safety is ensured.

In the sitting mode, the transverse shrinkage rods 40 are contracted, and the longitudinal shrinkage rods 50 are contracted, so that the overall gravity center is declined; meanwhile, the upper end of the cushion unit 70 can move to the lower parts of the sliding rails 60, so that the seat plate 72 is arranged horizontally; under the control of a rotating shaft of the chassis 10, the relative angle between a deformation part 19 and a support part 18 is further changed, and a foot pad 80 is controlled through a foot pad rotating shaft to rotate by a certain angle to adapt to the change of the sitting position; and in the sitting mode, the vehicle is permitted to run at medium-low speed.

In the driving mode, one ends of the transverse shrinkage rods 40 can move on the guide rails 90 away from the front wheel group 20, and move to the farthest position, and meanwhile the transverse shrinkage rods 40 are contracted to the shortest distance; the upper ends of the longitudinal shrinkage rods 50 can move to the farthest position away from the front wheel group 20, and the longitudinal shrinkage rods 50 are contracted to the shortest distance; the upper end of the cushion unit 70 can move to the upper parts of the sliding rails 60, so that the angle of the chassis 10 and the form of the cushion unit 70 are changed to adapt to the running requirement of the vehicle; and in this mode, the vehicle can reach the highest running speed.

In the lying mode, the angle between the chassis 10 and the seat is closest to the position that people lay naturally, and in this state, a vehicle walking mechanism is locked through the locking device.

In this embodiment, the chassis 10 comprises a base 17, a foot pad, and sliding rails 60 and guide rails 90, and the sliding rails and the guide rails are located on the base 17; the foot pad and the base are hinged or installed on the chassis 10, or installed on a third rotating shaft or installed at the lower end of a support plate 71; in different modes of the electric vehicle, the relative angle between the foot pad and the base 17 is deformed to adapt to the requirements of different modes; the base 17 is arranged in an arched mode; and in the standing state, the foot pad is obliquely arranged upwards away from the ground, and the center of gravity is backward, so that the driving safety is improved.

In the embodiment, the lower part of the base 17 is connected with a front wheel group 20, and the upper part of the base 17 extends away from the lower part; and the relative fixation between the base 17 and the front wheel group 20 is achieved, and the base 17 has a support range to ensure, that the base plays a role in support of the driver.

Furthermore, the base 17 comprises a support part 18 and a deformation part 19, and the lower end of the deformation part 19 is connected with the front wheel group 20; the upper end of the deformation part 19 is hinged to the support part 18; the cushion unit 70 and the sliding rails 60 are arranged, on the upper end face of the deformation part 19, and the guide rails 90 are arranged on the lower end face of the deformation part 19; the rear wheel group 30 can move relative to the deformation part 19 through the guide rails 90, so that the relative angle between the deformation part 19 and a horizontal plane is changed and different modes are switched; in addition, the relative angle between the support part 18 and the deformation part 19 is changed to make the base 17 fit with the driver more properly; and the driving comfort, is improved.

In this embodiment, a fourth rotating shaft 14 is arranged on the base 17, and the deformation part 19 and the fourth rotating shaft 14 are fixedly arranged; specifically, the deformation part 19 and the fourth rotating shaft 14 are of a connecting structure assembled together, and can be connected in a movable or fixed way; the support part 18 and the fourth rotating shaft 14 are arranged in a movable way, and the swing of the support part 18 relative to the deformation part 19 is achieved, so that the angle between the support part 18 and the deformation part 19 is regulated; and the switching between the driving mode and the lying mode is achieved.

In this embodiment, a back cushion 15 and a headrest 16 are arranged on the support part 18, and in the forward direction, the back cushion 15 and the headrest 16 are arranged in an arched mode separately; when the driver drives the electric vehicle, the back cushion 15 plays a role in supporting, massaging and protecting the back of the driver, and meanwhile the driving comfort of the driver is improved; and the headrest 16 plays a role in supporting, massaging and protecting the head of the driver, and meanwhile, the driving comfort of the driver is improved.

In this embodiment, an inner space is formed between the cushion unit 70 and the base 17, and a control element 81 and/or a power supply 82 is arranged in the inner space; the power supply 82 is connected with the control element 81 electrically, and used for providing power to drive the front wheel group 20 and the rear wheel group 30 to work; in this way, the electric vehicle is controlled through the control element 81 to run, and the mode switching of the electric vehicle is further controlled through the control element 81; and the mode switching accuracy is ensured, and the driving safety is improved.

In this embodiment, a detection module of the power supply 82 is arranged on the control element 81, and the functions of charging protection, low voltage protection and discharge over-current protection of the power supply 82 are provided.

In this embodiment, the control element 81 is composed of an embedded micro-controller unit (MCU) and a sensor, and all the transverse shrinkage rods 40, the longitudinal shrinkage rods 50, the front wheel group 20, the rear wheel group 30 and the like of the electric vehicle are controlled through the MCU; the sensor is used for measuring the running speed, turning speed, acceleration and deceleration of the vehicle, and then feeding back to the MCU; each device on the vehicle is operated through the MCU according to the control commands of a user, and the vehicle running state is detected according to the sensor data; when a certain datum or some data of the sensor approach to the design critical value, the vehicle control is actively intervened through the MCU to avoid accidents.

In this embodiment, the power supply 82 is a power battery used for power supply to all structures, and the use requirements of the electric vehicle are met.

In this embodiment, the front wheel group 20 comprises a plurality of front wheels and steering structures, and the included angle between the wheels and the forward direction of the vehicle is controlled through the steering structures by the control element 81, so that control over the running direction of the electric vehicle is achieved.

In this embodiment, the rear wheel group 30 comprises a plurality of rear wheels, a power motor and a braking device, and the power motor is powered by the power supply 82; each rear wheel is driven by the power motor through the control element 81 to rotate, and the running speed and starting of the electric vehicle are controlled; and the rear wheels are braked through the braking device by the control element 81, and the electric vehicle is controlled to stop.

In this embodiment, the cushion unit 70 comprises a support plate 71, and the lower part of the support plate 71 is fixedly arranged; specifically, the lower end of the support plate 71 is used in connection with other components, and is of a non-suspended, structure; the upper part of the support plate 71 is hinged to the lower part of the seat plate 72, the upper part of the seat plate 72 is connected in a movable way with the sliding rails 60; through change of the included angle between the support plate 71 and the seat plate 72, and cooperation between the seat plate 72 and the sliding rails, the form change of the cushion unit 70 is achieved; and the requirements of different modes of the electric vehicle are met.

In this embodiment, locking structures used for relatively fixing the upper part of the seat plate 72 and the sliding rails 60 are arranged on the sliding rails 60, and the locking structures are arranged, at the upper parts and lower parts of the sliding rails 60; the locking structures are connected with the control element 81 electrically; and under the effect of the locking structures, the mode fixation is achieved, and wrong switching among the modes is avoided in the using process of the electric vehicle, so that the driving safety is improved.

In this embodiment, each locking structure comprises a locking shaft, and a locking hole is formed in the first rotating shaft 11; the locking shaft, is controlled through the control element 81 to move and embed into the locking hole, and, the locking of the seat plate 72 is achieved. The locking structures can be further composed of a ratchet wheel, toggle piece and control element which are installed on the seat plate 72 and can move with the seat plate 72, and the toggle piece can be of a needle type, and is connected with the control element 81 through a spring; and the control element 81 can be solenoid valve and the like. When the position needs to be switched, the toggle piece is poked through the control element 81; at the moment, the spring is compressed, and the ratchet wheel is electrically controlled to rotate so that the seat plate is driven to move; when the seat plate moves to the corresponding position, the toggle piece is poked; the toggle piece is pressed into a gear gap of the ratchet wheel under the effect of the spring, and the locking is finished.

In this embodiment, each guide rail 90 comprises a longitudinal rod sliding section 92 and a cross rod sliding section 91, and the longitudinal rod sliding section 92 and the cross rod sliding section 91 are arranged in an up-and-down butt joint mode or the cross rod sliding section and the longitudinal rod sliding section are integrally arranged without a block in the middle; one end of the transverse shrinkage rod 40 is connected in a movable way with the cross rod sliding section 91, and the other end of the transverse shrinkage rod 40 and the rear wheel group 30 are fixedly arranged; the lower end of the longitudinal shrinkage rod 50 is attached to the rear wheel group 30; the upper end of the longitudinal shrinkage rod 50 is connected in a movable way with the longitudinal rod sliding section 92; when one end of the transverse shrinkage rod 40 is located at the upper end of the cross rod sliding section 91, and the upper end of the longitudinal shrinkage rod 50 is located at the upper end of the longitudinal rod sliding section 92, the vehicle is in the driving mode; and the movement of the longitudinal shrinkage rod 50 and the transverse shrinkage rod 40 is achieved, and the mode switching is achieved.

Furthermore, limiting plates are arranged on the guide rails 90, and the limiting plates 97 are located between the longitudinal rod sliding section 92 and the cross rod sliding section 91 or two top ends; one end of the transverse shrinkage rod 40 is limited through the limiting plates to move to the longitudinal rod sliding section 92, and the upper end of the longitudinal shrinkage rod 50 is limited through the limiting, plates to move to the cross rod sliding section 91, or the transverse shrinkage rod 40 and the longitudinal shrinkage rod 50 are limited to slide out of the sliding rails; and under the effect of the limiting, plates, mutual effect of the longitudinal shrinkage rod 50 and the transverse shrinkage rod 40 is avoided effectively, and the mode switching of the electric vehicle is ensured.

Specifically, the locking device is arranged on the transformable electric vehicle, and comprises a parking system and a sliding rail locking device. In the lying state, the parking system can be a common electronic parking system, etc. The front wheel group 20 and the rear wheel group 30 are limited through the locking device to work, and the transformable electric vehicle is in a stopping state; in the lying state, the electric vehicle is in the stopping state, and facilitates the driver to have a rest, and the safety is ensured.

In the variable-form cushion structure of electric vehicle, the first rotating shaft 11 is arranged at the upper end of the seat plate 72; the first rotating shaft 11 is arranged transversely, and the first rotating shaft 11 and the chassis 10 are fixedly arranged; specifically, the first rotating shaft 11 and the chassis 10 are of the connecting structure assembled together, and are, connected in a movable or slidable way; and the setting stability of the first rotating shaft 11 is ensured; the sliding rails 60 run through the first rotating shaft 11, and in the longitudinal direction, the first rotating shaft 11 can move relative to the sliding rails 60, so as to achieve the switching between horizontal arrangement and oblique arrangement of the seat plate 72; and in this way, the deformation of the seat plate 72 is facilitated.

Furthermore, in the transverse direction, locating wheels are arranged at two ends of the first rotating shaft 11 separately, and two locating grooves are formed in the chassis 10; the two locating wheels are embedded into the two locating grooves separately: and under the cooperation effect of the locating wheels and the locating grooves, the situation that the first rotating shaft 11 is deviated during movement and consequently the deformation of the seat plate 72 is affected is avoided.

The second rotating shaft 12 is arranged at the upper end of the support plate 71, and the lower end of the seat plate 72 is connected in a movable way with the second rotating shaft 12; the second rotating, shaft 12 and the first rotating shaft 11 are arranged in parallel; under the effect of the second rotating shaft 12, the relative movement between the support plate 71 and the seat plate 72 is facilitated, thereby facilitating switching between the horizontal arrangement and oblique arrangement of the seat plate 72.

In addition, the second rotating shaft 12 plays a role in strengthening the cushion unit 70, so that the overall structure of the cushion unit 70 is more stable; and the second rotating shaft 12 benefits strengthening of the bearing capability of the cushion unit 70, and the service life of the cushion unit 70 is prolonged.

The seat plate 72 comprises a flat part 721 and a bending part 722, and the lower end of the flat part 721 is connected in a movable way with the second rotating shaft 12; the lower part of the bending part 722 and the lower end of the flat part 721 are arranged in a butt joint mode; from the lower part of the bending part 722 to the upper part of the bending part 722, the bending part 722 is bent towards the sliding rails 60 gradually; under the effect of the bending part 722, the driver sits on the seat plate 72, and the gravity center of the driver faces backward to avoid the situation that the driver slides forwards, and consequently the driver is affected to sit on the seat plate 72.

Furthermore, the bending part 722 is arranged in an arched mode outwards; the advantages of such arrangement are that the fitting effect between the bending part 722 and the driver is improved, and the comfort of the driver is improved.

The chassis 10 comprises a foot pad; a third rotating shaft 13 is arranged at the lower end of the support plate 71, and is arranged transversely; the third rotating shaft 13 and the chassis 10 are fixedly arranged, and specifically the third rotating shaft 13 and the chassis 10 are of the connecting structure assembled together, and can be connected in a movable or fixed way; the support plate 71 rotates around the third rotating shaft 13 or the third rotating shaft 13 is driven by the support plate 71 to rotate around the chassis 10, and the foot pad is connected in a movable way with the third rotating shaft 13; the relative angle between the foot pad and the support plate 71, and between the support plate 71 and the deformation part 19 is changed through the third rotating shaft 13, so that the foot pad and the support plate adapt to different modes, and the use comfort of the electric vehicle is improved. In addition, the foot pad can be further installed at the lower end of the chassis 10 or the lower end of the support plate 71.

The foot pad is obliquely arranged upwards away from the ground, so that the gravity center of the driver faces backwards, and the driving safety of the driver is improved.

The chassis 10 comprises the base 17, and the sliding rails 60 are arranged on the base 17; the lower end of the support plate 71 and the base 17 are arranged fixedly, and specifically the lower end of the support plate 71 and the base 17 are of the connecting structure assembled together; the support plate 71 is connected with the set position of the lower end of the base 17 through the third rotating shaft 13, and the third rotating shaft is installed on the base; the support plate 71 is assembled on the third rotating shaft 13, and can rotate around the third rotating shaft 13; or the third rotating shaft is installed on the support plate 71, and driven by the support plate 71 to rotate around the chassis 10.

From the lower end of the support plate 71 to the front side of the upper end of the support plate 71, the support plate 71 is obliquely arranged away from the base 17 gradually; and through such arrangement, and in different modes, the influence of the support plate 71 on the driver is minimum, and the support plate plays a role in supporting the driver.

The base 17 is arranged in the arch mode away from the support plate 71; in this way, the distance of the base 17 and the support plate 71 is longer, so that the inner space is larger, and arrangement of the control element 81 and the power supply 82 is facilitated.

In this embodiment, each transverse shrinkage rod 40 comprises a first roller 42 and a retractable or telescopic first rod body 41, and one end of the first rod body 41 and the first roller 42 are fixedly arranged; the other end of the first rod body 41 and the rear wheel group 30 are arranged fixedly; a first mounting groove is formed in the first roller 42; the cross rod sliding section 91 is embedded into the first mounting groove; through stretching and contraction of the first rod body 41, the fine regulation of the distance between the front wheel group 20 and the rear wheel group 30 is achieved, and through the first roller 42 and a second roller 52, the relative movement among the transverse shrinkage rods 40, the longitudinal shrinkage rods 50, the rear wheel group 30 and the guide rails 90 is achieved; under the effect of the first mounting groove, the function of guiding the first roller 42 to move is achieved, and the movement of the first roller 42 is facilitated.

Furthermore, a lower end face is formed on the chassis 10, and the guide rails 90 are formed on the lower end face of the chassis 10; the first mounting groove comprises two first groove walls arranged oppositely, and a clearance is formed between the two first groove walls; and the cross rod sliding section 91 is located in the clearance, and the first roller 42 is prevented from being deviated during movement.

In addition, the outer end faces of the first groove walls abut against the lower end face of the chassis 10; in this way, when the first roller 42 moves, the first groove walls are fit with the lower end face of the chassis 10, and the moving stability of the first roller 42 is improved.

The first groove walls are arranged circularly, and the outer end faces of the first groove walls are arranged in the arched mode outwards; and the movement of the first roller 42 is facilitated, and the friction force of the first groove walls to the lower end face of the chassis 10 is reduced, thereby facilitating movement of the first roller 42.

In order to achieve the locking of the transverse shrinkage rods 40 and the longitudinal shrinkage rods 50, sliding rail locking devices are arranged on the first roller 42 and the second roller 52 and in the guide rail ranges where the first roller 42 and the second roller 52 can slide, and the locking structures between the sliding rails 60 and the seat plate 72 can be further achieved in the same mode, shown as follows:

The first fixing grooves are formed in the two first groove walls, and in the width direction of the cross rod sliding section 91, two first fixing strips 93 are arranged on the cross rod, sliding section 91, extend in the length direction of the cross rod sliding section 91, and run through the fixing grooves; through cooperation of the first fixing strips 93 and the first fixing grooves, the situation that the first roller 93 is deviated excessively and consequently the movement of the first roller 42 is affected is avoided; and in addition, under the effect of the first fixing strips, the first roller 42 is prevented from being separated from the chassis 10.

The first mounting grooves comprise the first groove bottoms, and the first reinforcing blocks are arranged at the first groove bottoms; the first reinforcing holes 95 are formed in the cross rod sliding section 91; when the first reinforcing blocks are embedded into the first reinforcing holes 95, the first roller 42 and the cross rod sliding section 91 are relatively fixed; through cooperation of a first fixing hole and a first fixing block, the fixing effect of the first roller 42 and the cross rod sliding section 91 is improved, and wrong switching between the modes is avoided; and the driving safety is ensured.

The upper end and the lower end of the cross rod sliding section 91 are each provided with the first reinforcing hole 95; when the electric vehicle is in the standing mode or the sitting mode, the first reinforcing hole 95 in the upper, end of the cross rod sliding section 91 is cooperated with the first fixing block, so that the fixation of the standing mode or the sitting mode is achieved, and the use of the standing mode or the sitting mode is ensured; when the electric vehicle is in the driving mode or the lying mode, the first reinforcing hole 95 in the lower end of the cross rod sliding section 91 is cooperated with the first fixing block, so that the fixation of the driving mode or the lying mode is achieved, and the use of the driving mode or the lying mode is ensured.

Each guide rail 90 of the electric vehicle structurally comprises the control element 81, and one first groove wall of the guide, rail is controlled through the control element 81 to reciprocate towards the other first groove wall for clamping or loosening the cross rod sliding section 91; when the electric vehicle is used, after the mode is selected, the cross rod sliding, section 91 is clamped through the two first groove walls, and the relative fixing effect between the first roller 42 and the cross rod sliding section 91 is improved; the use of each mode is ensured; when the modes are switched, the cross rod sliding section 91 is loosened through the two first groove, walls, so that the movement of the first roller 42 is facilitated.

Specifically, each longitudinal shrinkage rod 50 comprises a second roller 52 and a retractable or telescopic second rod body 51, and one end of the second rod body 51 and the second roller 52 are fixedly arranged; the other end of the second rod body 51 and the rear wheel group 30 are arranged fixedly; a second mounting groove is formed in the second roller 52; the longitudinal rod sliding section 92 is embedded into the second mounting groove; through stretching and contraction of the second rod body 51, the regulation of height and angle of the chassis 10 is achieved, and through the second roller 52, the relative movement between the longitudinal shrinkage rods 50 and the guide rails 90 is achieved; under the effect of the second mounting groove, the function of guiding the second roller 52 to move is achieved, and the movement of the second roller 52 is facilitated.

Furthermore, the second mounting groove comprises two second groove walls arranged oppositely, and a clearance is formed between the two second groove walls; and the longitudinal rod sliding section 92 is located in the clearance, and the second roller 52 is prevented from being deviated during movement.

In addition, the outer end faces of the second groove walls abut against the lower end face of the chassis 10; in this way, when the second roller 52 moves, the second groove walls are fit with the lower end face of the chassis 10, and the moving stability of the second roller 52 is improved.

The second groove walls are arranged circularly, and the outer end faces of the second groove walls are arranged outwards in the arched mode; and the movement of the second roller 52 is facilitated, and the friction force of the second groove walls 10 to the lower end face of the chassis 10 is reduced, thereby facilitating movement of the second roller 52.

The second fixing grooves are formed in the two second groove walls, and in the width direction of the longitudinal rod sliding section 92, two second fixing strips 94 are arranged, on the longitudinal rod sliding section 92, extend in the length direction of the longitudinal rod sliding section 92, and run through the fixing grooves; through cooperation of the second fixing strips 94 and the second fixing grooves, the situation that the second roller 52 is deviated excessively and consequently the movement of the second roller 52 is affected is avoided; and in addition, under the effect of the second fixing strips, the second roller 52 is prevented from being separated from the chassis 10.

The second mounting grooves comprise the second groove bottoms, and the second reinforcing blocks are arranged at the second groove bottoms; the second reinforcing holes 96 are formed in the longitudinal rod sliding section 92; when the second reinforcing blocks are embedded into the second reinforcing holes 96, the second roller 52 and the longitudinal rod sliding section 92 are relatively fixed; through cooperation of the second fixing hole and the second fixing block, the fixing effect of the second roller 52 and the longitudinal rod sliding section 92 is improved, and wrong switching between the modes is avoided; and the driving safety is ensured.

The upper end and the lower end of the longitudinal rod sliding section 92 are each provided with the second reinforcing hole 96; when the electric vehicle is in the standing mode or the sitting mode, the second reinforcing hole 96 in the lower end of the longitudinal rod sliding section 92 is cooperated with the second fixing block, so that the fixation of the standing mode or the sitting mode is achieved, and the use of the standing mode or the sitting mode is ensured; when the electric vehicle is in the driving mode or the lying mode, the second reinforcing hole 96 in the upper end of the longitudinal rod sliding section 92 is cooperated with the second fixing block, so that the fixation of the driving mode or the lying mode is achieved, and the use of the driving mode or the lying mode is ensured.

One second groove wall is controlled through the control element 81 to reciprocate towards the other second groove wall for clamping or loosening the longitudinal rod sliding section 92; when the electric vehicle is used, after the mode is selected, the longitudinal rod sliding section 92 is clamped through the two second groove walls, and the relative fixing effect between the second roller 52 and the longitudinal rod sliding section 92 is improved; the use of each mode is ensured; when the modes are switched, the longitudinal rod sliding section 92 is loosened through the two second groove walls, so that the movement of the second roller and the switching among the modes are facilitated.

The longitudinal rod sliding section 92 and the cross rod sliding section 91 are integrally arranged, and materials saved: repeated installation is not required, and the installation of the guide rails 90 is facilitated.

In the width direction of the guide rails 90, each limiting plate 97 has a transverse distance, and the first roller 42 has a transverse width; the transverse distance of the limiting plate 97 is larger than the transverse width of the first roller 42; it is ensured that each limiting plate 97 has a sufficient limiting range, and the first roller 42 is prevented from entering the longitudinal rod sliding rod 92 or sliding out from the guide rail 90.

In addition, under the effect of the limiting plates 97, the situation that the second roller 52 enters the cross rod sliding section 91 and consequently the first roller 42 is collided with the second roller 52 is avoided effectively.

A plurality of position sensors are arranged on the electric vehicle, and each position sensor corresponds to each mode; the position sensors are electrically connected with the control element 81 separately, thereby facilitating monitoring of the modes and switching between the modes through the control element 81.

A concave space is formed between the bending part 722 and the back cushion 15; when the driver uses the electric vehicle, and the electric vehicle is in the driving mode or the lying mode, the buttocks of the driver sit in the concave space, and the driving comfort of the driver is improved; and meanwhile the driving safety of the driver is improved.

The front wheel group 20 is connected in a movable way with the chassis 10, so that the fixation of the front wheel group 20 is achieved; the overall stability of the electric vehicle is improved, and the use of the electric vehicle is facilitated; and the use safety is ensured.

The front wheel group 20 is connected in a movable way with the cushion unit 70, so that the fixation of the front wheel group 20 is achieved; the overall stability of the electric vehicle is improved, and the use of the electric vehicle is facilitated; and the use safety is ensured.

The distance between the front wheel group 20 and the footstep of the driver is fixed, similarly to pulleys, through driving of the rear wheel group 30, the foot of the driver applies force, and the forward direction of the front wheel group 20 is changed; and the steering and the use of the electric vehicle are achieved, and the driving fun is improved.

The above mentioned content is only the preferable embodiments of the utility model, and is not limited to the utility model. Any modification, equivalent replacement and improvement, permutation and combination, etc. made according to the spirit and principles of the utility model shall be included in the protection scope of the utility model.

1. A variable-form cushion structure of electric vehicle is characterized by comprising a chassis with sliding rails, and a cushion unit, wherein, the chassis is arranged longitudinally, and the sliding rails extend longitudinally; the cushion unit comprises a support plate and a seat plate, and the lower end of the seat plate is hinged to the upper end of the support plate; the lower end of the support plate is fixedly arranged, and the upper end of the seat plate is connected in a movable way with the sliding rails: when the upper end of the seat plate is located at the upper parts of the sliding rails, the seat plate is obliquely arranged relative to the ground; and when the upper end of the seat plate moves to the lower parts of the sliding grails, the seat plate is arranged horizontally.

2. The variable-form cushion structure of electric vehicle according to claim 1, characterized in that a first rotating shaft is arranged at the upper end of the seat plate; the first rotating shaft is arranged transversely, and attached to the chassis; and the sliding rails run through the first rotating shaft, and in the longitudinal direction, the first rotating shaft can move relative to the sliding rails, so as to achieve the switching between horizontal arrangement and oblique arrangement of the seat plate.

3. The variable-form cushion structure of electric vehicle according to claim 1, characterized in that the first rotating shaft is arranged at the upper end of the seat plate; the first rotating shaft is arranged transversely, and connected in a movable or slidable way with the chassis; and the first rotating shaft can move relative to the sliding rails, so as to achieve the switching between horizontal arrangement and oblique arrangement of the seat plate.

4. The transformable electric vehicle according to claim 1, characterized in that locking structures used for relatively fixing the upper part of the seat plate to the chassis are arranged between the seat plate and the chassis.

5. The variable-form cushion structure of electric vehicle according to claim 2, characterized in that a second rotating shaft is arranged at the upper end of the support plate, and the lower end of the seat plate is connected in a movable way with the second rotating shaft; and the second rotating shaft as well as the first rotating shaft are arranged in parallel.

6. The variable-form cushion structure of electric vehicle according to claim 1, characterized in that an inner space is formed between the cushion unit and the chassis, and control elements and/or power supplies are arranged in the inner space.

7. The variable-form cushion structure of electric vehicle according to claim 1, characterized in, that the chassis comprises a foot pad; a third rotating shaft is arranged at the lower end of the support plate; the third rotating shaft is arranged transversely, and the third rotating shaft attached to the chassis; and the foot pad is connected in a movable way with the third rotating shaft.

8. The variable-form cushion structure of electric vehicle according to claim 1, characterized in that the chassis comprises the foot pad; the third rotating shaft is arranged at the lower end of the support plate; the third rotating shaft is arranged transversely and the third rotating shaft connected with the chassis, and the foot pad is installed on the chassis or at the lower end of the support plate.

9. The variable-form cushion structure of electric vehicle according to claim 1, characterized in that the chassis comprises a base, and the sliding rails are arranged on the base; the lower end of the support plate is attached to the base, and from the lower end of the support plate to the upper end of the support plate, the support plate is gradually inclined away from the base.

10. The variable-form cushion structure of electric vehicle according to claim 7, characterized in that the support plate is connected with the set position of the lower end of the base through the third rotating shaft, and the third rotating shaft is installed on the base; the support plate is assembled on the third rotating shaft, and it can rotate around the third rotating shaft; or the third rotating shaft is installed on the support plate, and driven by the support plate to rotate around the chassis.
